(19) United States
(12) Patent Application Publication
(10) Pub. No.: US 2008/0205212 A1
(43) Pub. Date: Aug. 28, 2008

(54) OPTICAL HEAD APPARATUS, INFORMATION RECORDING/REPRODUCING APPARATUS INCLUDING THE OPTICAL HEAD APPARATUS, AND INFORMATION RECORDING/REPRODUCING METHOD

(75) Inventors: Takehiro Hiramatsu, Yokohama-shi (JP); Hideaki Ohsawa, Yokohama-shi (JP); Kazuo Watabe, Yokohama-shi (JP); Chosaku Noda, Yokohama-shi (JP); Naoki Morishita, Yokohama-shi (JP); Akihito Ogawa, Yokohama-shi (JP); Kazuto Kuroda, Yokohama-shi (JP); Nobuaki Kaji, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/039,648

(22) Filed: Feb. 28, 2008

(30) Foreign Application Priority Data
Feb. 28, 2007 (JP) 2007-050311

(51) Int. Cl. G11B 7/004

(52) U.S. Cl. 369/44.28; 369/112.05

(57) ABSTRACT

According to one embodiment, an optical head device provides a signal processing circuit which sets a control amount to move an objective lens so that a distance between the objective lens and a given recording layer of the an optical disc coincides with a focal position, an optical path length correction mechanism which corrects an influence of an aberration component producing an error in the focal distance, a thickness difference detection circuit which finds an amount of correction to be made by the optical path length, and an aberration correction circuit which generates a correction signal to correct the influence of the aberration component producing the error in the focal distance detected by the thickness difference detection circuit, and supplies the correction signal to the optical path length correction mechanism.

### CROSS-REFERENCE TO RELATED APPLICATIONS

This application is based upon and claims the benefit of priority from Japanese Patent Application No. 2007-050311, filed Feb. 28, 2007, the entire contents of which are incorporated herein by reference.

### BACKGROUND

1. Field

One embodiment of the present invention relates to an information recording/reproducing apparatus and an information recording/reproducing method, which can record information on an information recording medium capable of recording information by using light with two wavelengths.

2. Description of the Related Art

In optical discs such as a DVD-R disc and a DVD-RW available on the market, address information is previously recorded in a land pre-pit, and a record mark is formed on a wobbled pre-groove.

A reproducing signal from a land pre-pit or a pre-groove is used for reproducing address information or as a tracking servo signal. For stable tracking and correct reproduction of address information, the shape of a land pre-pit or a pre-groove is optimized such that a reproducing signal becomes larger.

A current optical disc drive also adopts a method of optimizing recording conditions, such as a recording power and a recording pulse width, in order to realize more stable information recording.

For example, Japanese Patent Application Publication (KOKAI) No. 2001-266362 discloses

a) a large detection signal is obtained from a land pre-pit to ensure the reliability of reproduction from address information recorded in a land pre-pit, and

b) a large track displacement detection signal is obtained from a pre-groove to ensure high tracking stability at the time of forming a record mark, when a record mark is newly recorded on an information recording medium having a pre-groove and a land pre-pit.

In the Japanese Patent Application Publication (KOKAI) No. 2004-192679 explains an example of calculating optimum recording power, or optimizing recording conditions when recording information, based on a detected value of an optical phase difference among optical discs.

In the Japanese Patent Application Publication (KOKAI) No. 6-131688 discloses an example using a reproducing light sources and a recording light source, which are different in the wavelength of output laser beams.

However, in a read-only DVD-ROM disc, address information and tracks are formed by a record mark formed in an emboss pit, and a land pre-pit and a pre-groove are not formed. Therefore, a read-only optical disc drive is optimized for reproducing information of a record mark, and if a reproducing signal of a land pre-pit or pre-groove specific to a recording optical disc is mixed there, it becomes a noise component. In this case, even if a recording condition is an optimized recording mark, a reproducing characteristic is degraded.

In the example shown in the Publication No. 2001-266362, as the wavelength of a laser beam for tracking when recording a record mark is the same as the wavelength of a laser beam for reproducing information from a record mark, the following problems occur.

1. A crosstalk signal from a land pre-pit is mixed into a reproducing signal from a record mark, and the characteristic of a reproducing signal from a record mark is degraded, and the reliability of reproduction from a record mark is largely lowered.

2. By the influence of a diffracted light from a pre-groove, the characteristic of track displacement detection by a differential phase detect (DPD) method is degraded, and the stability of detection of a track displacement from a record mark is lowered.

3. As a DC level from a pre-groove is decreased upon reproduction, the amplitude of a reproducing signal from a record mark is lowered, and the reliability of reproduction from a record mark is largely lowered.

Even by changing the wavelengths of laser beams for recording and reproducing as shown in the Publication No. 2004-192679 or 6-131688, it is difficult to increase the amplitude of a signal upon reproduction as indicated in the Publication No. 2001-266362.

As described above, there is a problem that the record mark reading characteristic is different between a current DVD-R/DVD-RW disc and a read-only DVD-ROM.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc drive according to an embodiment of the invention;

FIG. 2A is an exemplary diagram showing an example of arrangement of photodetecting areas in a photodetector incorporated in an optical head of the optical disc drive shown in FIG. 1, according to an embodiment of the invention

FIG. 2B is an exemplary diagram showing an example of arrangement of photodetecting areas in a photodetector incorporated in an optical head of the optical disc drive shown in FIG. 1, according to an embodiment of the invention;

FIG. 3 is a graph explaining an example of a relationship between the absorbance (reflection characteristic) of a recording layer of a recording medium and the wavelengths of light from first and second light sources for recording by using the optical disc drive shown in FIG. 1, according to an embodiment of the invention;

FIG. 4 is an exemplary diagram showing an example of an optical head apparatus of the optical disc drive shown in FIG. 1, according to an embodiment of the invention;

FIG. 5 is an exemplary diagram showing an example of another optical head apparatus of the optical disc drive shown in FIG. 1, according to an embodiment of the invention;

FIG. 6 is an exemplary diagram showing an example of another optical head apparatus of the optical disc drive shown in FIG. 1, according to an embodiment of the invention;

FIG. 7 is an exemplary diagram showing an example of another optical head apparatus of the optical disc drive shown in FIG. 1, according to an embodiment of the invention;

FIG. 8 is an exemplary diagram showing an example of another optical head apparatus of the optical disc drive shown in FIG. 1, according to an embodiment of the invention;

FIG. 9 is an exemplary diagram showing an example of another optical head apparatus of the optical disc drive shown in FIG. 1, according to an embodiment of the invention;

FIG. 10 is an exemplary diagram showing an example of another optical head apparatus of the optical disc drive shown in FIG. 1, according to an embodiment of the invention;

FIG. 11 is a graph explaining an example of a relationship between a groove depth and a push-pull signal amplitude when light with a wavelength of 405 nm is condensed by an objective lens with NA=0.65, according to an embodiment of the invention; and

FIG. 12 is a graph explaining an example of a relationship between a groove depth and a push-pull signal amplitude when light with a wavelength of 650 nm is condensed by an objective lens with NA=0.60, according to an embodiment of the invention.

### DETAILED DESCRIPTION

Various embodiments according to the invention will be described hereinafter with reference to the accompanying drawings. In general, according to one embodiment of the invention, an optical head device for recording information on a recording medium which reflects light from a first light source to output light with a first wavelength by a predetermined light power, and diffracts a little light from a second light source to output a light with a second wavelength longer than the light with a first wavelength from the first light source in a non-recording state, comprising: an objective lens which condenses the light from the first and second light sources on a recording layer of a recording medium; an actuator which movably holds the objective lens to permit focusing to match a focal position of the objective lens with a recording layer of a recording medium, and to permit tracking to match the light condensed by the objective lens with a predetermined position in the radial direction of a recording medium; and a photodetector which outputs a signal corresponding to the light power mount of a reflected light from a recording layer of a recording medium captured by the objective lens, wherein recording information on a recording layer of a recording medium by the light emitted from the second light source, simultaneously outputting light from the first and second light sources, controlling a position of the objective lens in the direction of an optical axis by the light emitted from the first or second light source and reflected from recording layer of a recording medium, and controlling a position of the object lens in the radial direction of a recording medium by the output of the photo-detector which detects a component of the light emitted from the first light source and reflected from a recording layer of a recording medium, and wherein reproducing information recorded on a recording medium is only by the light emitted from the second light source, and controlling a position of the objective lens in the direction of an optical axis and in the radial direction of a recording medium by the output of the photo-detector which detects a component of the light emitted from the second light source and reflected from a recording layer of a recording medium.

Embodiments of this invention will be described in detail with reference to the drawings.

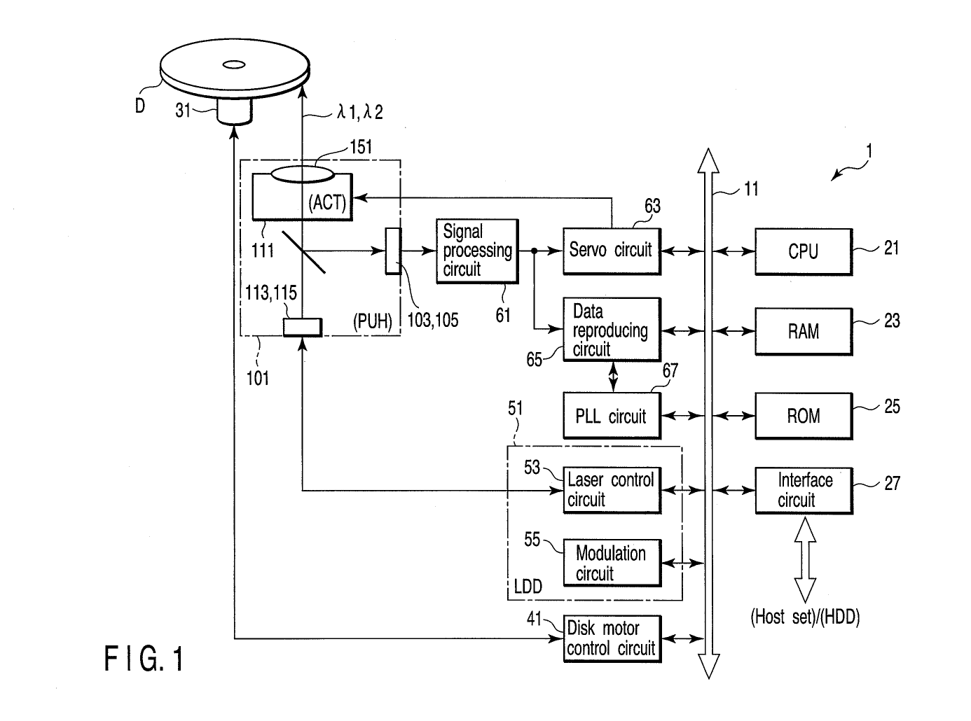

An optical disc drive (disc drive) 1 shown in FIG. 1 has a disc motor 31 which supports and rotates a recording medium, or an optical disc D at a predetermined speed, and a pickup (optical) head (PUH) 101 which is located at a predetermined position to a recording surface of the optical disc D, records information on the recording surface of the optical disc D, or reproduces information from the recoding surface of the optical disc D.

The PUH 101 includes a first semiconductor laser element (LD 1) 113 capable of outputting a laser beam with a first wavelength, a second semiconductor laser element (LD 2) 115 capable of outputting a laser beam with a second wavelength longer than the first wavelength, an objective lens 151 which guides laser beams from the first and second laser elements to a recording surface of an optical disc D, and captures a reflected laser beam reflected from the recording surface of the optical disc D, and an actuator (ACT) 111 holding the objective lens 151, as explained later.

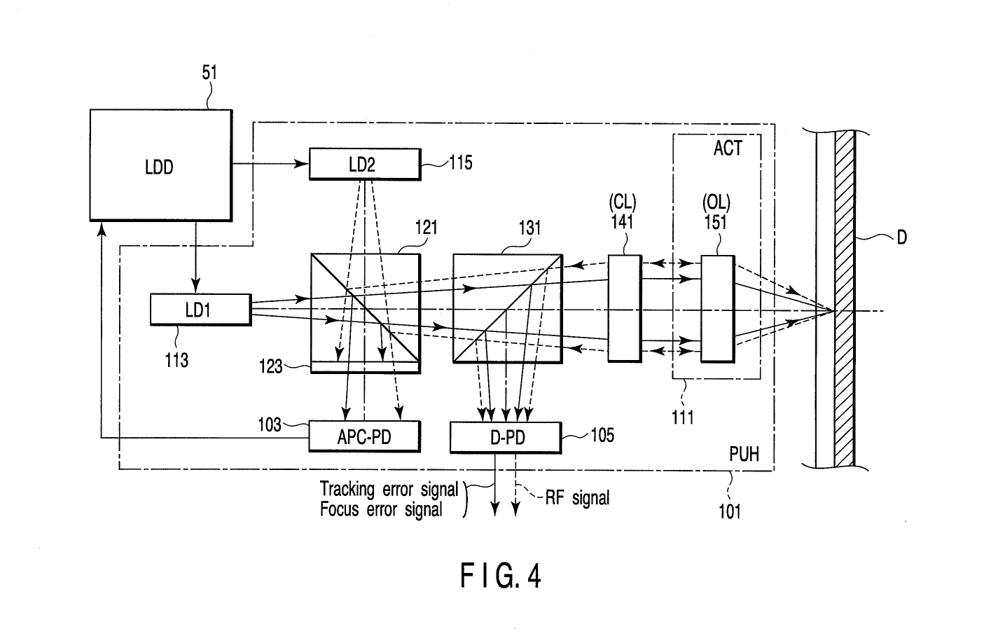

The PUH 101 has a monitoring photodetector (APC-PD, in FIG. 4) 103 which detects laser beams for monitoring from the first and second semiconductor laser elements, converts them into signals corresponding to the intensities of those laser beams, and outputs the signals, and a data photodetector (D-PD, in FIG. 4) 105 which detects reflected laser beams from the recording surface of the optical disc D, converts them into signals corresponding to the intensity of those laser beams, and outputs the signals, and other various optical elements to be described later.

The optical disc drive 1 has a CPU 21, a RAM 23, a ROM 25 and an interface 27, which are connected to a bus 11. The bus 11 is connected to a signal processing circuit 61 to give a predetermined characteristic to the output from the D-PD 105 of the PUH 101, a servo circuit 63 to control a position of an ACT 111 by using the output from the signal processing circuit 61, and a data reproducing circuit 65 to reproduce data (information) recorded in the optical disc D from the output of the signal processing circuit. The bus 11 is also connected to a PLL circuit 67, a laser drive circuit (laser diode driver, LDD) 51, and a disc motor control circuit 41. The LDD 51 includes a laser control circuit 53 and a modulation circuit 55, controls the strengths and waveforms of laser beams output from the first and second laser elements mounted in the PUH 101, and controls the output and stop of a laser beam. The LDD 51 can drive the first and second semiconductor laser elements at the same time.

In the optical disc drive 1 shown in FIG. 1, the PUH 101 is moved in the radial direction (the tracking direction) of the optical disc D by a not-shown pickup feeding mechanism.

The modulation circuit 55 modulates recording data supplied from a host set (an external apparatus) connected through the interface 27, at the time of recording information, and supplies the modulated data to the laser control circuit 53.

The laser control circuit 53 supplies a writing signal to at least one of the first and second laser elements in the PUH 101, at the time of recording information (at the time of forming a mark), based on the modulated data supplied from the modulation circuit 55. At the time of reproducing information, a laser beam fixed to a reproducing power is supplied to at least one of the first and second laser elements of the PUH 101.

The laser beam according to a signal supplied from the laser control circuit 53 output from the PUH 101 is focused on the optical disc D. A monitoring signal corresponding to the intensity of a laser beam is generated by a monitoring PD 103 of the PUH 101, and output to the laser control circuit 55. Then, a writing signal is adjusted.

An output signal based on a reflected light from the optical disc D is generated by the data PD 105 of the PUH 101, and supplied to the servo circuit 63 and data reproducing circuit 65 through the signal processing circuit 61. The signal processing circuit 61 generates a focus error signal and a tracking signal, and outputs them to the servo circuit 63.

The servo circuit 63 generates a focusing control signal and a tracking signal for controlling the position of the ACT 111, and outputs them to not-shown focus coil and tracking coil of the ACT 111. As a result, a laser beam condensed on the recording surface of the optical disc D by an objective lens of the ACT 111 is controlled to be just-focused on the recording layer of the recording surface of the optical disc D, and then controlled to follow a track.

The output from the signal processing circuit 61 supplied from the data reproducing circuit 65 is reproduced as recorded data (on the optical disk D), based on a reproducing clock signal from the phase-locked loop (PLL) circuit 67.

The reproduced data reproduced by the data reproducing circuit 65 is output to a host set (an external apparatus) or a storage device (an HDD or a work memory) through the interface circuit 27.

It is needless to say that the disc motor control circuit 41, modulation circuit 55 (LDD 51), laser control circuit 53 (LDD 51), servo circuit 63, data reproducing circuit 65, and PLL circuit 67 are controlled by the central processing unit (CPU) 21. The CPU 21 controls all operations of the optical disc drive 1, according to operation commands supplied from the host set through the interface circuit 27. The CPU 21 uses the random access memory (RAM) 23 as a work area, and is operated according to a program stored in the read-only memory (ROM) 25. This is not substantially different from a known disc drive apparatus, and explanation will be omitted.

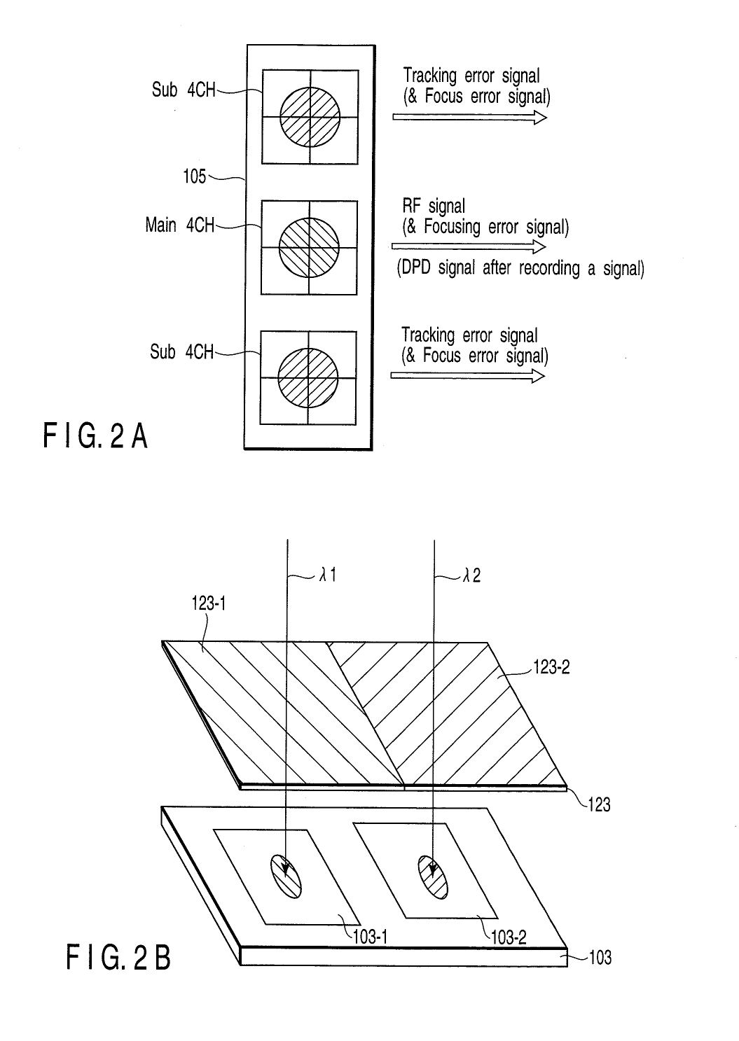

Next, an explanation will be given on a photodetector incorporated in an optical head (PUH) of the optical disc drive shown in FIG. 1 by using FIG. 2A. A photodetector (PD) is available in two types, a monitoring PD for monitoring the intensities of laser beams with first and second wavelengths (photodiode integrated circuit [PDIC]), and a data PD (PDIC) as explained later. In FIG. 2A, a data PD (D-PDIC 105) will be explained. In FIG. 2B, a monitoring PD (APC-PDIC 103) will be explained.

The data PDIC 105 has a main photodetecting area at a position in the optical head (PUH 101, FIG. 1) including a designed optical axis (also called an optical axis of a system) passing through the center of an objective lens described later. In many cases, a pair of (two) sub photodetecting areas is provided on both sides of the main photodetecting area. Each photodetecting area is divided into four parts by division lines intersecting at right angles. Namely, each photodetecting area has 4 channels.

Each photodetecting area receives light with a wavelength 1 (400 to 410 nm), outputs a push-pull (PP) signal usable for a focus error signal and a tracking error signal, and outputs a data reproducing signal, or radio frequency (RF) signal from an area to receive light with a wavelength 2 (650 to 680 nm).

For example, the data PDIC 105 shown in FIG. 2A can receive a laser beam with the wavelength 2 in a central (main) photodetecting area, and can obtain an RF signal by signal processing by the data reproducing circuit 65. The data PDIC 105 can also receive a laser beam with the wavelength 1 reflected from the recording layer of the recording surface of the optical disc D in two sub photodetecting areas, and can obtain a tracking signal.

It is possible to obtain a focus error signal by using the outputs of four channels (CH) of the central (main) photodetecting area. Further, it is also possible to obtain a differential phase detection (DPD) signal by using the outputs of four channels of the central area. Therefore, it is possible to perform tracking even for an optical disc having a record mark (a string of pits) by DPD by using a laser beam with the wavelength 2.

The monitoring PDIC 103 is provided at a predetermined position in the optical head (PUH) 101, and has a photodetecting area 103-1 to receive light with the wavelength 1 (400 to 410 nm), and a photodetecting area 103-2 to receive light with the wavelength 2 (650 to 680 nm), as shown in FIG. 4 to FIG. 10. Each photodetecting area outputs a signal linearly proportional to the optical output emitted from each laser element.

A filter or a polarizer 123 may be provided between the PDIC 103 and a beam splitter (a dichroic prism described later with reference to FIG. 4 to FIG. 10). The filter or a polarizer 123 capable of transmitting a laser beam with a wavelength corresponding to the photodetecting areas 103-1 and 103-2 has been shown in FIG. 2B. In this case, a laser beam with one of the wavelengths is interrupted or reduced in intensity by the corresponding photodetecting area 123-1 or 123-2, and only a laser beam with one of the wavelengths is applied to each photodetecting area. Therefore, a noise is reduced, or a detection error is prevented. The same effect can be obtained by evaporating a thin film to transmit only a laser beam with the wavelength 1 and a thin film to transmit only a laser beam with the wavelength 2 (thin films capable of transmitting laser beams with corresponding wavelengths) on a cover glass of the PDIC (APC-PD) 103, instead of using the filter 123.

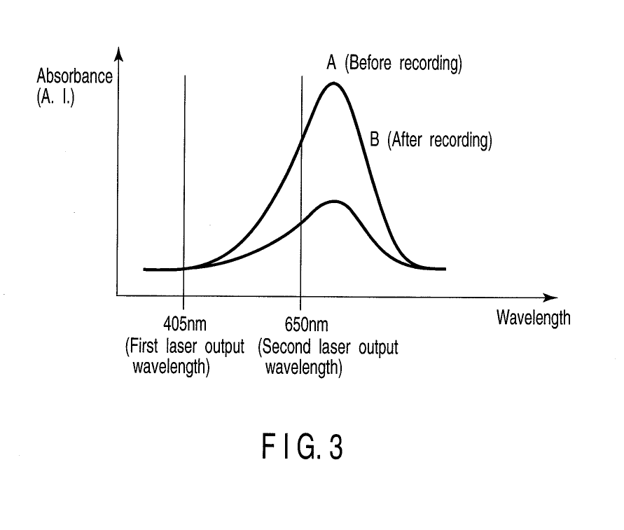

FIG. 3 shows an example of the characteristics of a recording medium usable when changing wavelengths of laser beams for recording and reproducing, that is, a recording layer of a recording surface of an optical disc D, in the optical disc drive shown in FIG. 1. First and second wavelengths are set to 400 to 410 and 650 to 680 nm, respectively, because of the following reason (has been shown).

In current DVD-R and DVD-RW discs, 650±5 nm is assumed to be a wavelength of light for reproducing. Therefore, a laser beam with a wavelength of 650 nm can be obtained by using the PUH 101 of the optical disc drive shown in FIG. 1. Further, as a recording layer of an optical disc having the characteristic (absorbance) shown in FIG. 3, it is required to be reproduced by a laser beam with the wavelength of 650±5 nm, to ensure reproduction compatibility between current DVD-R and DVD-RW discs.

Actually, an optical disc having a wide usable wavelength range is advantageous in cost performance, and reproducible by a 650±5 nm laser beam. Therefore, one of wavelengths of a laser beam to be output from a laser element mounted in the PUH 101 is decided to 650±5 nm.

A wavelength λw used for a laser beam used for tracking may be any value shorter than 650 nm. In contrast, as a laser beam (a semiconductor laser source) with a wavelength of 405 nm has been used in the HD DVD and Blu-ray disc (BD) standards, one of wavelengths of a laser beam to be output from a laser element mounted in the PUH 101 is desirably 405±5 nm.

As recording is performed by using light with a wavelength of 650 nm, the characteristic (absorbance) of the recording layer of the optical disc shown in FIG. 3 is preferably higher in a wavelength of 650 nm (second wavelength) than in a wavelength of 405 nm (first wavelength) either before recording denotes with curve A or after recording denotes with curve B, and the absorbance for the second wavelength is preferably lower after recording compared with before recording.

Namely, the characteristic of the recording layer of the optical disc shown in FIG. 3 shows a peak of absorbance in a wavelength longer than the second wavelength (red). When recording or reproducing information by using a laser beam with the second wavelength, a laser beam with the first wavelength is substantially not absorbed, and reflectivity for a laser beam with the first wavelength is substantially constant, regardless of whether recording is made by using a laser beam with the second wavelength.

Therefore, by using a recording layer having the absorbance (reflectivity) shown in FIG. 3, stable tracking is possible without changing an offset of a tracking signal. It should be noted that when reflectivity (absorbance) is different in recording and non-recording (existence of recording) for a laser beam with the first wavelength, a difference in brightness (reflection) in a recording area and a non-recording area (existence of recording) becomes an offset of a push-pull signal, and stable tracking is difficult.

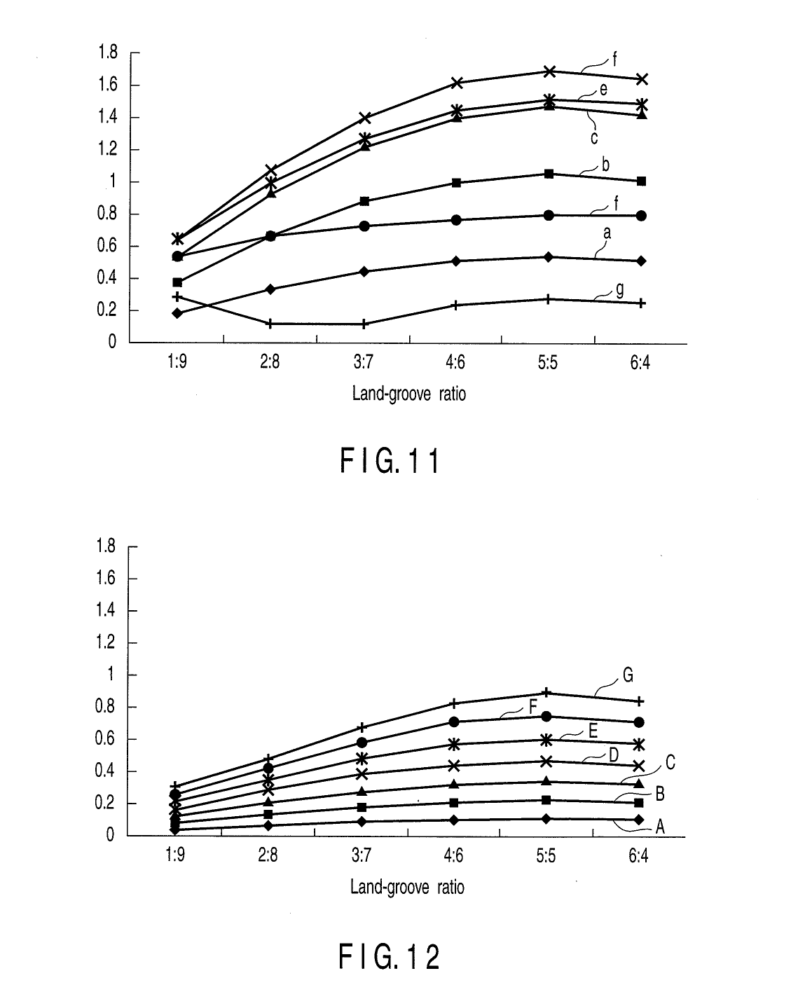

The depth of land/groove specific to an optical disc can be obtained from the result of simulation showing the relationship between the groove depth and push-pull signal amplitude when a laser beam with a wavelength of 405 nm is condensed by an objective lens with a numerical aperture (NA) of 0.65, as shown in FIG. 11, and the result of simulation showing the relationship between the groove depth and push-pull signal amplitude when a laser beam with a wavelength of 650 nm is condensed by an objective lens of NA=0.6, as shown in FIG. 12.

FIG. 11 shows the calculation of changes in the output when the ratio of the width of a land to the width of a groove at the center of a trapezoidal slope is changed, assuming the depth of a pre-groove to be a parameter. In FIG. 11, the curve a shows an example with a groove depth of 10 nm, the curve b shows an example with a groove depth of 20 nm, the curve c shows an example with a groove depth of 30 nm, the curve d shows an example with a groove depth of 40 nm, the curve e shows an example with a groove depth of 50 nm, the curve f shows an example with a groove depth of 60 nm, and the curve q shows an example with a groove depth of 70 nm, respectively. FIG. 12 shows the result of simulation when a recording light with a wavelength of 650 nm is condensed by an objective lens with the NA of 0.6 under the same conditions. In FIG. 12, the curves A to G indicate the groove depths, and correspond to those written in lowercase shown in FIG. 11.

Namely, the push-pull signal amplitude is very large in FIG. 11, compared with FIG. 12.

For example, when the depth of a groove of a recording layer of an optical disc D is 20 nm, the width of a push-pull signal is large for a laser beam with the wavelength 1 (405 nm), but small for a laser beam with the wavelength 2 (650 nm). By giving such a groove to the recording layer of the optical disc D, a push-pull signal is substantially not output when reproducing the optical disc D with a laser beam with the wavelength 2, after recording a signal on an optical disc by tracking by a laser beam with the wavelength 1. As a result, the influence of a track cross (crosstalk) in a focus signal is reduced, and stable focusing is possible. Even when reproducing a recorded optical disc by a second laser beam by using optional optical head and optical disc drive specific to a current DVD standard optical disc, as a record mark (a string of pits) is recorded, tracking in the DPD method is possible, and no problem arises from the fact that a push-pull signal is not output.

FIG. 4 shows a preferable embodiment of an optical head (PUH) incorporated in the optical disc drive shown in FIG. 1.

An optical head (PUH) 101 shown in FIG. 4 has a blue laser element (LD 1) 113 (to output a laser beam with a first wavelength), a red laser element (LD 2) 115 (to output a laser beam with a second wavelength), a dichroic prism 121, a polarization beam splitter 131, a collimator lens (CL) 141, an objective lens (OL) 151, a monitoring photodiode integrated circuit (PDIC) 103 (photodetector) for auto power control (APC), a data PDIC 105 (photodetector), and an actuator (ACT) 11.

The wavelength of a laser beam output from the first laser element (LD 1) 113 is 405±5 nm (400 to 410 nm), and blue, as already explained.

The wavelength of a laser beam output from the second laser element (LD 2) 115 is 650 to 680 nm (or 650±15 nm), and red, as already explained.

The dichroic prism 121 transmits most (over 90%) of a laser beam with a first wavelength, and reflects most (over 90%) of a laser beam with a second wavelength.

The polarization beam splitter 131 transmits a p-polarized light beam, and reflects an s-polarized light beam.

The APC PDIC 103 consists of two or more photodetecting areas (usually, one main area and two sub-areas on both sides) partitioned by division lines intersecting at right angles, as shown in FIG. 2B, and can independently monitor (receive) laser beams with the wavelengths 1 and 2. For example, a focus error signal and a tracking error signal (a push-pull signal) are obtained from the area (main area) to receive light with the wavelength 1.

As shown in FIG. 2B, the APC PDIC 103 has two photodetecting areas to receive light with the wavelength 1 (400 to 410 nm) and light with the wavelength 2 (650 to 680 nm), respectively. The light with the wavelength 1 and light with the wavelength 2 guided to the APC PDIC 103 is optimized in the photodetecting areas and wavelengths by the polarizer or filter 123 provided between the dichroic prism 121 and APC PDIC 103.

The data PDIC 105 consists of two or more photodetecting areas (usually, one main area and two sub-areas on both sides) partitioned by division lines intersection at right angles, as shown in FIG. 2A. A focus error signal and a data output (a RF signal) are obtained from the area (main area) to receive light with the wavelength 2. If information has been recorded on a disc, a DPD signal is also obtained.

In the optical head (PUH) 101 shown in FIG. 4, the blue laser element (LD 1) 113 outputs laser beam having p-polarization and the first wavelength, and at the same time, the red laser element (LD 2) 115 outputs laser beam having p-polarization and the second wavelength.

The light with the first wavelength (indicated by a solid line) passes through the dichroic prism 121, and the light with the second wavelength (indicated by a broken line) reflects on the dichroic prism 121. The first laser element (LD 1) 113 and second laser element (LD2) 115 are arranged, so that the output lights with the first and second wavelengths are positioned on the same axial line.

The light with the first wavelength passing through the dichroic prism 121 and the light with the second wavelength reflected from the dichroic prism 121 are transmitted through the polarization beam splitter 131, converted to parallel light by the collimator lens (CL) 141, transmitted through a not-shown λ4 plate, given a predetermined convergence by the objective lens (OL) 151, and condensed on the recording layer of the recording surface of the optical disc D.

The reflected laser beams (the laser beams with the first and second wavelengths overlapped) reflected from the recording surface of the optical disc D are captured by the objective lens 151, converted to parallel light, transmitted through a not-shown λ/4 plate and turned 90 degree compared with the laser beam having the polarizing direction toward the optical disc D, and changed from a p-polarized beam to a s-polarized beam.

The reflected laser beam transmitted through the %/4 plate is given convergence by the collimator lens 141, and applied to the polarization beam splitter 131. At this time, as the polarizing direction is changed to a s-polarization, then the reflected laser beam is reflected toward the data PDIC 105.

Thereafter, the reflected laser beam is photoelectrically converted by the PDIC 105, and supplied to the signal processing circuit 61 (refer to FIG. 1). The output of the PDIC 105 is converted to the predetermined characteristic or output format demanded by the servo circuit 63 (FIG. 1) and data reproduction circuit 65 (refer to FIG. 1), by the signal processing circuit 61 when it is output from the optical head (PUH) 101. As shown in FIG. 2A, the PDIC 105 has three photodetecting areas, a central (main) area and sub areas (two on both sides), and they correspond to a 0th-order light or a light beam on the axis guided to the main (central) photodetecting area, and a ±1^{st}-order light beam guided to the sub areas (two on both sides), when a not-shown diffraction element or a hologram plate having a predetermined diffraction pattern is inserted between the dichroic prism 121 and collimator lens 141, for example. Therefore, a focus error signal and data output (RF signal) are obtained from the output of the PDIC 105. If information has been recorded on a disc, a DPD signal is also obtained.

A laser beam with the first wavelength reflected from the dichroic prism 121 by a predetermined ratio and a laser beam with the second wavelength passing through the dichroic prism 121 by a predetermined ratio are guided to the APC PDIC 103, photoelectrically converted by the PDIC 103, and supplied to the laser control circuit 53 (refer to FIG. 1) of the LDD 51. Then, the first and second laser beams are set to predetermined intensities.

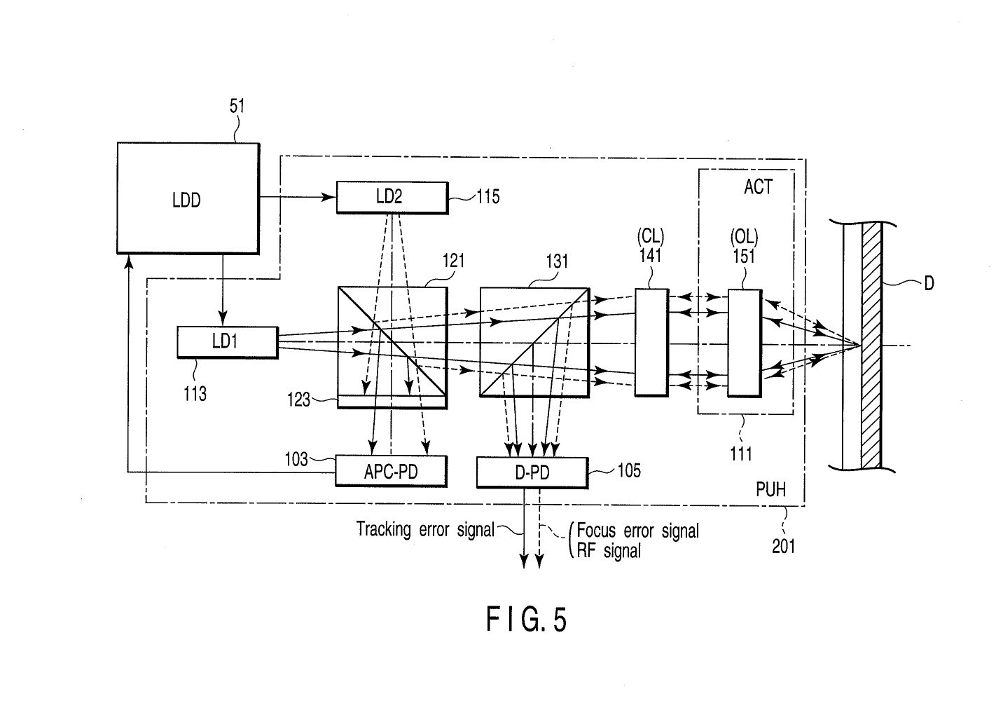

FIG. 5 shows another preferable embodiment of an optical head (PUH) incorporated in the optical disc drive shown in FIG. 1 (the optical head and signal processing shown in FIG. 4 are different). The components substantially the same as those shown in FIG. 4 are given the same reference numbers, and detailed explanation on these components will be omitted.

An optical head (PUH) 201 shown in FIG. 5, records data by using a laser beam with the wavelength 2 from the LD 2 (red), by tracking by using a laser beam with the wavelength 1 from the LD 1 (blue) 113, after focusing by using a laser beam with the wavelength 2 from the LD 2 (red).

The data PDIC 105 obtains a focus error signal and an RF signal from a laser beam with the second wavelength output from the main photodetecting area diagrammatically shown in FIG. 2A, and obtains a tracking error signal from a laser beam with the first wavelength output from the sub photodetecting areas (two).

Namely, as a laser beam with the wavelength 2 is used for focusing, a spot of a laser beam with the wavelength 2 emitted from the objective lens (OL) 151 can be condensed without defocusing. By obtaining a tracking error signal from a laser beam with the wavelength 1, even if a recording layer of an optical disc is displaced from a focal position of the objective lens 151, a tracking error signal can be obtained without being so influenced in contradistinction to an RF signal.

The output of the APC PDIC 103 is used for setting the intensity of a laser beam output from each laser element, as in the example of FIG. 4.

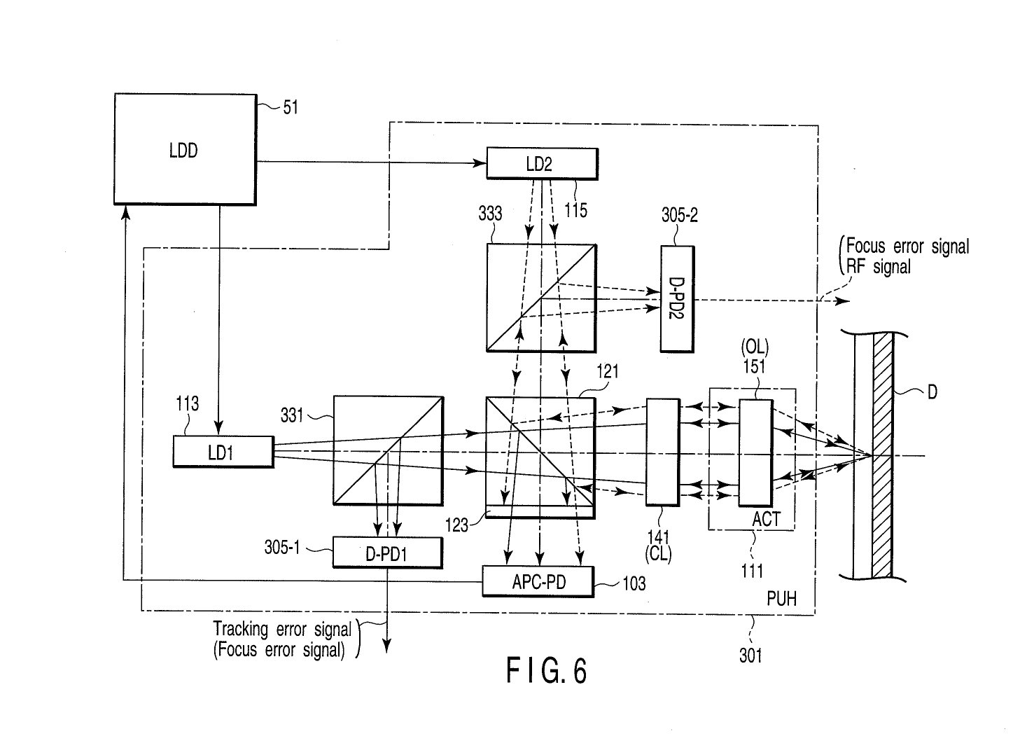

FIG. 6 shows another preferable embodiment of an optical head (PUH) incorporated in the optical disc drive shown in FIG. 1. The components substantially the same as those shown in FIG. 4 are given the same reference numbers, and detailed explanation on these components will be omitted.

In an optical head (PUH) 301 shown in FIG. 6, independently provided first and second data PDIC (D-PD 1) 305-1 and (D-PD 2) 305-2 receive, respectively, a laser beam with the wavelength 1 from the LD 1 (blue), and a reflected laser beam of a laser beam with the wavelength 2 emitted from the LD 2 (red) and reflected from the recording surface of an optical disc D. As two data PDIC 305-1 and 305-2 are used, the dichroic prism 121 is arranged close to the collimator lens 141, and a first polarization beam splitter 331 is positioned between the LD 1 (blue) 113 and dichroic prism 121, and a second polarization beam splitter 333 is positioned between the LD 2 (red) 115 and dichroic prism 121.

By using the PUH 301 shown in FIG. 6, when recording on an optical disc capable of recording at a highly increased speed, even if the power of a laser beam with the wavelength 2 reaches 10 times of the power of a laser beam with the wavelength 1, a scattered light of a laser beam with the wavelength 2 does not enter a photodetecting area to receive light with the wavelength 1 (305-1) when receiving a laser beam with the wavelength 1, and S/N (ratio of signal/noise) is improved.

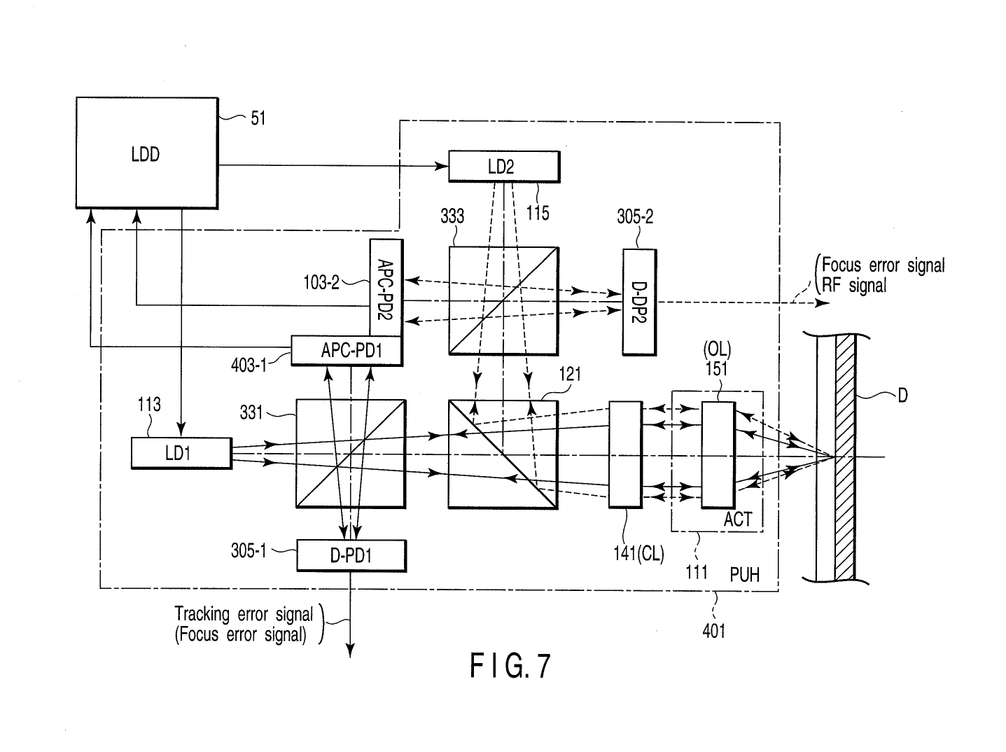

FIG. 7 shows a still another preferable embodiment of an optical head (PUH) incorporated in the optical disc drive shown in FIG. 1. The components substantially the same as those shown in FIG. 4 are given the same reference numbers, and detailed explanation on these components will be omitted.

In an optical head (PUH) 401 shown in FIG. 7, the PUH 301 shown in FIG. 6 is configured as an independent detection system from the viewpoint of APC, and a laser beam with the wavelength 1 from the LD 1 (blue) 113 and a laser beam with the wavelength 2 from the LD 2 (red) 115 are received by independently provided a first APC PDIC (APC-PD 1) 463-1 and a second APC PDIC (APC-PD 2) 463-2 to monitor the laser beams, respectively. As two APC PDIC 463-1 and 463-2 are used, the dichroic prism 121 is arranged close to the collimator lens 141, and a first polarization beam splitter 331 is positioned between the LD 1 (blue) 113 and dichroic prism 121, and a second polarization beam splitter 333 is positioned between the LD 2 (red) 115 and dichroic prism 121.

By using the PUH 401 shown in FIG. 7, when recording data on an optical disc capable of recording at a highly increased speed, even if the power of a laser beam with the wavelength 2 reaches 10 times of the power of a laser beam with the wavelength 1, reception of a laser beam with the wavelength 1 is hardly affected by a scattered light of a laser beam with the wavelength 2, and an influence upon detection sensitivity caused by a different dynamic range can be reduced, compared with the case of using a single APC PDIC.

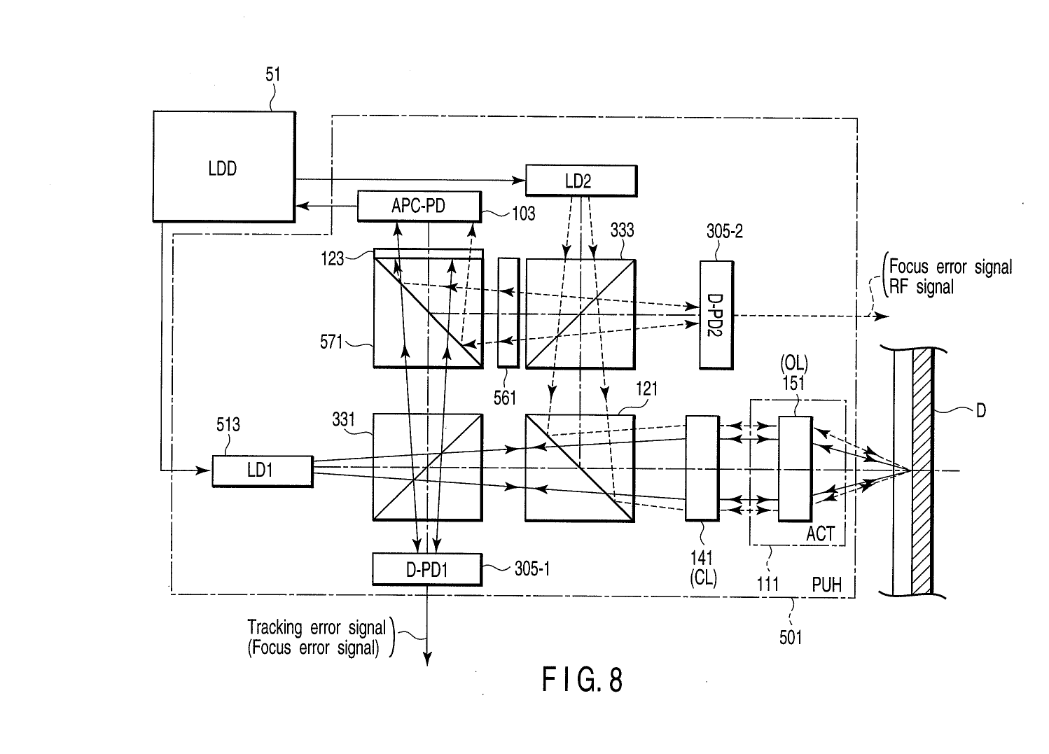

FIG. 8 shows another preferable embodiment of an optical head (PUH) shown in FIGS. 4, 6 and 7. The components substantially the same as those shown in FIGS. 4, 6 and 7 are given the same reference numbers, and detailed explanation on these components will be omitted.

In an optical head (PUH) 501 shown in FIG. 8, as the APC PDIC 103 is commonly used for the laser beams with the first and second wavelengths, the dichroic prism 121 is arranged close to the collimator lens 141, the first polarization beam splitter 331 is positioned between the LD 1 (blue) 113 and dichroic prism 121, the second polarization beam splitter 333 is positioned between the LD 2 (red) 115 and dichroic prism 121, a laser beam with the first wavelength branched by the first polarization beam splitter 331 is directly guided to the APC PDIC 103, and a laser beam with the second wavelength branched by the second polarization beam splitter 333 is guided to the APC PDIC 103 through a neutral density (ND) filter 561 and second dichroic prism 571.

By using the optical head (PUH) shown in FIG. 8, the light amount (power) of a laser beam with the wavelength 2 guided to the APC PDIC 103 can be set to the same as the light amount (power) of a laser beam with the wavelength 1, and the load to the APC PDIC 103 is reduced (a special PDIC considering a dynamic range becomes unnecessary).

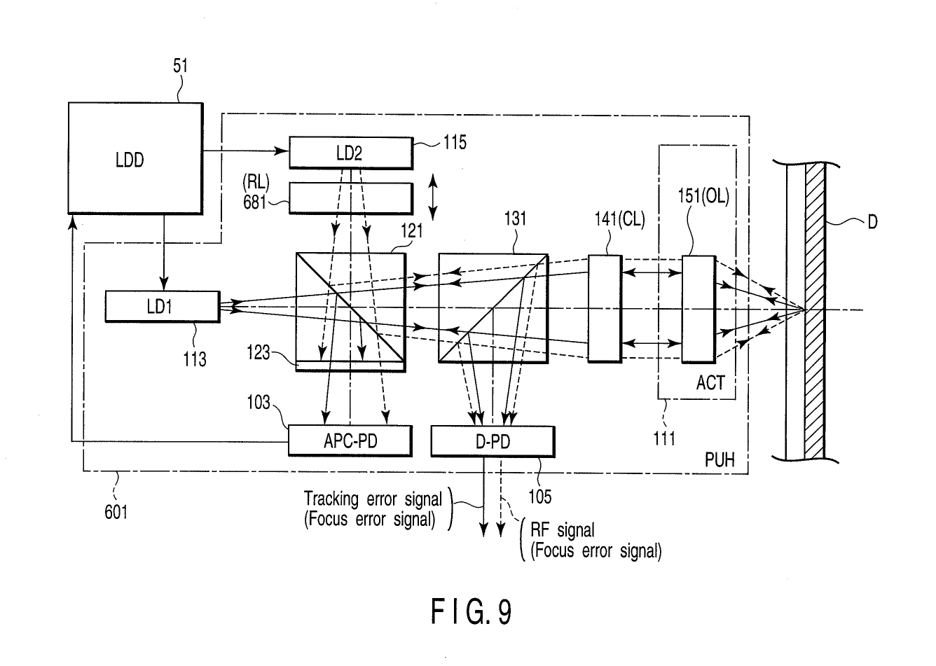

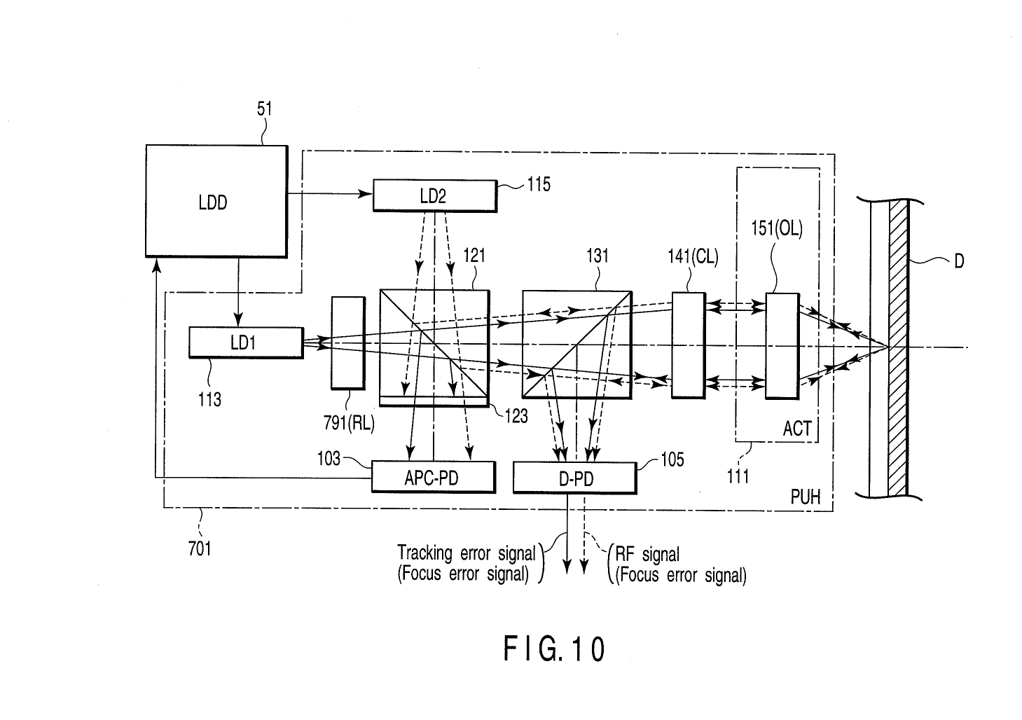

FIG. 9 and FIG. 10 show a still another preferable embodiment of an optical head (PUH) incorporated in the optical disc drive shown in FIG. 1. The components substantially the same as those shown in the most similar PUH 201 shown in FIG. 5 or the PUH 101 shown in FIG. 4 are given the same reference numbers, and detailed explanation on these components will be omitted.

A PUH 601 shown in FIG. 9 corrects a focus displacement of a laser beam with the wavelength 2 by using a movable (relay) lens (RL) 681 between the dichroic prism 121 and the second laser element (LD 2) 115 to output a laser beam with the wavelength 2.

Namely, a focus of a laser beam with the wavelength 2 is corrected by adjusting the position of the movable (relay) lens 681 to obtain a best RF signal with the wavelength 2, thereby realizing stable focus control compared with a system (FIG. 5) not provided with the movable (relay) lens 681. At the same time, the time required by the focus control is reduced.

As in a PUH 701 shown in FIG. 10, when obtaining a tracking error signal from a laser beam with the wavelength 1 by focusing by using a laser beam with the wavelength 2, it is also possible to correct a focus displacement of a laser beam with the wavelength 1 by providing a movable (relay) lens 791 between the dichroic prism 121 and the LD 1 (blue) to output a laser beam with the wavelength 1.

In the system shown in FIG. 10, the position of the movable (relay) lens 791 is set a position which is a position with a tracking signal output from a PDIC for the wavelength 1 becomes maximum and a focus of a laser beam with the wavelength 1 is just on focused.

For example, by simultaneously lighting the laser element (LD 1) 113 for the wavelength 1 and the laser element (LD 2) 115 for the second wavelength, and by obtaining focus error signals of both laser elements at the same time, it is possible to detect a focus displacement of a laser beam with each wavelength (a displacement from a focus position of an objective lens), to perform focusing and tracking by using a laser beam with the wavelength 1, and to perform recording by using a laser beam with the wavelength 2.

For example, when recording, a predetermined offset may be added to a focus error signal, so that a size of the beam spot becomes minimum with respect to light with the wavelength 2. And for example, In this case, by adjusting an optical path length of a laser beam with at least one of the wavelengths by a corresponding movable (relay) lens, as in the system shown in FIG. 9 or FIG. 10.

As explained above, it is possible to record information at a highly increased speed (several or several ten times higher) on a write-once optical disc (a recording medium), which outputs a push-pull signal when receiving a laser beam with the wavelength 1 (400 to 410 nm) of the present invention and outputs almost no push-pull signal when receiving a laser beam with the wavelength 2 (650 to 680 nm), by using a laser beam with the second wavelength 2 for recording.

Namely, according to the invention, when recording data on a write-once optical disc medium, which outputs a push-pull signal when receiving a laser beam with the wavelength 1 (400 to 410 nm) of the present invention and outputs almost no push-pull signal when receiving a laser beam with the wavelength 2 (650 to 680 nm), as it is impossible to follow (track) a face wobble before recording with the wavelength 2, a record mark to permit reading a signal by light with the wavelength 2 is formed on the medium by tracking with the wavelength 1, or by recording by light with the wavelength 1 or 2. As tracking by light with the wavelength 2 is possible by using the DPD method after recording, reproduction is possible only by light with the wavelength 2.

Further, according to the invention, as a maximum output of semiconductor laser having the wavelength 2 is larger than the output of a semiconductor laser having the wavelength 1, recording at a highly increased speed is possible by using a semiconductor laser having the wavelength 2. Further, as the wavelength 2 is longer than the wavelength 1, it is necessary to increase NA in order to realize the same spot size. But, when a spreading angle and optical magnification of a laser beam from LD are equal in the wavelengths 1 and 2, a beam using efficiency is increased when the NA is high. Therefore, from this point of view, recording by using the wavelength 2 is advantageous in the power.

Further, when the working distances of the wavelengths 1 and 2 are different when recording, there arise a problem that when focusing by using the wavelength 1, and the light with the wavelength 2 is defocused and a spot of the wavelength 2 cannot be condensed. According to the invention, in the example shown in FIG. 4, this problem is solved by setting the working distance of an objective lens substantially the same for light with the wavelengths 1 and light with the wavelength 2. In the example shown in FIG. 5, this problem is solved by focusing by using light with the wavelength 2.

Namely, by using the invention, it is possible to record data on a write-once optical disc medium, which outputs a push-pull signal when receiving a laser beam with the wavelength 1 (400 to 410 nm) of the present invention and outputs almost no push-pull signal when receiving a laser beam with the wavelength 2 (650 to 680 nm), by the same wavelength as a reproducing wavelength, by tracking by using a laser beam with the wavelength 1, and by recording by using a laser beam with the wavelength 2. Namely, when recording on a medium, it is easily possible to optimize recording conditions to obtain the best quality of a reproducing signal. In addition, when reproducing data, it is possible to obtain a reproducing signal with good quality with less influences of land pre-pit and pre-groove.

Further, in a semiconductor laser used for an optical disc drive, a laser beam with the wavelength 2 is lower in cost and larger in output. Therefore, it is possible to manufacture at low cost an optical disc drive capable of recording on a write-once optical disc which outputs a push-pull signal when receiving a laser beam with the wavelength 1 (400 to 410 nm) of the present invention and outputs almost no push-pull signal when receiving a laser beam with the wavelength 2 (650 to 680 nm), at a highly increased speed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions. What is claimed is:

1. An optical head device for recording information on a recording medium that reflects light from a first light source to output light with a first wavelength at a predetermined light power, and that diffracts a portion of light from a second light source to output light with a second wavelength longer than the first wavelength in a non-recording state, the device comprising:
an objective lens configured to condense the light from the first and second light sources on a recording layer of a recording medium;
an actuator configured to movably hold the objective lens to permit focusing to match a focal position of the objective lens with the recording layer, and to permit tracking to match the light condensed by the objective lens with a predetermined position in the radial direction of the recording medium; and
a photodetector configured to output a signal corresponding to the light power of reflected light from the recording layer that is captured by the objective lens,
wherein the optical head device is configured to perform a method comprising:
recording information on the recording layer of the recording medium with light emitted from the second light source while simultaneously outputting light from the first and second light sources,
while recording information on the recording layer, controlling the position of the objective lens in the direction of the optical axis based on the light emitted from the first or second light sources, and controlling the position of the objective lens in the radial direction of the recording medium based on an output of the photo-detector comprising a detected component of the light emitted from the first light source and reflected from the recording layer of the recording medium, and
wherein
reproducing information recorded on the recording medium is performed only by the light emitted from the second light source, and
while reproducing information recorded on the recording medium, controlling the position of the objective lens in the direction of the optical axis and in the radial direction of the recording medium is performed based on an output of the photo-detector comprising a detected component of the light emitted from the second light source and reflected from the recording layer of the recording medium.

2. The optical head device of claim 1, wherein a relay lens is provided in at least one of the optical paths between the objective lens and the first light source, and between the objective lens and the second light source.

3. An information recording and reproducing apparatus comprising an optical head apparatus for recording information on a recording medium that reflects light from a first light source, and that diffracts a portion of light from the second light source in a non-recording state, the optical head apparatus comprising:
the first light source to output light with a first wavelength,
a second light source to output light with a second wavelength longer than the first wavelength,
an objective lens to condense the light from the first and second light sources on a recording layer of a recording medium,
an actuator configured to movably hold the objective lens to permit focusing to match a focal position of the objective lens with the recording layer of the recording medium, and to permit tracking to match the light condensed by the objective lens with a predetermined position in the radial direction of the recording medium,
a photodetector configured to output a signal corresponding to the light power of reflected light from the recording layer of the recording medium captured by the objective lens;
a modulation circuit configured to modulate the light with the first wavelength from the first light source of the optical head apparatus with information to be recorded to the recording medium; and
a data reproducing circuit configured to reproduce the information recorded on the recording medium based on outputs from the photodetector,
wherein the optical head apparatus of the information recording and reproducing apparatus is configured to perform a method comprising:
recording information on the recording layer of the recording medium using the light emitted from the second light source while simultaneously outputting light from the first and second light sources,
while recording information on the recording layer, controlling a position of the objective lens in the direction of an optical axis based on the light emitted from the first or second light sources and reflected from recording layer of a recording medium, and controlling a position of the object lens in the radial direction of the recording medium based on an output of the photo-detector comprising a detected component of the light emitted from the first light source and reflected from the recording layer of the recording medium,
and wherein
reproducing information recorded on a recording medium is performed only by the light emitted from the second light source, and
while reproducing information recorded on the recording medium, controlling a position of the objective lens in the direction of an optical axis and in the radial direction of a recording medium is performed based on an output of the photo-detector comprising a detected component of the light emitted from the second light source and reflected from the recording layer of the recording medium.

4. The apparatus of claim 3, further comprising a relay lens provided in at least one of the optical paths between the objective lens and the first light source, or between the objective lens and the second light source.

5. An information recording and reproducing method comprising:
simultaneously outputting light from first and second light sources;
controlling a position of an objective lens in the direction of an optical axis based on the light emitted from the first of second light sources and reflected from a recording layer of a recording medium;
controlling a position of the objective lens in the radial direction of a recording medium based on an output of a photodetector comprising a detected component of a light beam emitted from the first light source and reflected from the recording layer of the recording medium;
recording information on the recording layer of the recording medium with the light from the second light source; and
outputting only the light from the second light source, and controlling the position of the objective lens in the direction of the optical axis and in the radial direction of the recording medium based on an output of the photodetector comprising a detected component of the light emitted from the second light source and reflected from the recording layer of the recording medium, thereby reproducing information recorded on the recording medium.
